(19) United States
(12) Patent Application Publication
(10) Pub. No.: US 2017/0158353 A1
(43) Pub. Date: Jun. 8, 2017

(54) Remote Aerodrome for UAVs

(71) Applicant: Mark Schmick, San Francisco, CA (US)

(72) Inventor: Mark Schmick, San Francisco, CA (US)

(21) Appl. No.: 15/230,467

(22) Filed: Aug. 7, 2016

Related U.S. Application Data
(60) Provisional application No. 62/202,716, filed on Aug. 7, 2015.

(51) Int. Cl. B64F 1/22; B64C 39/02; B64D 47/08; B60L 11/18; E06B 9/58; E06B 9/68; E06B 9/15; B64F 1/00; G05D 1/00

(52) U.S. Cl. CPC B64F 1/22; B64F 1/005; B64C 39/024; B64D 47/08; G05D 1/0038; G05D 1/0033; E06B 9/581; E06B 9/68; E06B 9/15; B64F 1/222; B60L 11/1816; B60L 11/182; B64C 2201/141

(57) ABSTRACT

An Aerodrome providing safe storage for Unmanned Aerial Vehicles (UAVs) that includes an enclosure to protect UAVs from the elements (weather). The Aerodrome includes an enclosure, a foldable flight deck, a service interface, and a telescoping video and audio feed unit. The aerodrome can be remotely operated, and can be mounted on a roof of a structure or vehicle, allowing a completely automated service of the UAV without the need of a person being physically present in the vicinity of the UAV.

### CROSS REFERENCE TO RELATED APPLICATIONS

This Application claims priority date to a U.S. Provisional Patent Application No. 62/202,716 titled Automated Hangar and Flight Deck for Commodity UAVs.

### STATEMENT REGARDING FEDERALLY SPONSORED RESEARCH AND DEVELOPMENT

None.

### FIELD OF THE INVENTION

The present invention relates to methods and mechanisms required to launch, retrieve, maintain, and extract data from a Unmanned Aerial Vehicles (UAVs), also commonly known as drones, without the need of direct human interactions with the UAVs other than flying the drone. The automated hangar and flight deck (Aerodrome) for the commodity UAVs (drones) also provides safe storage for UAVs. The aerodrome includes an enclosure to protect UAVs from the elements (weather). The Aerodrome includes a foldable flight deck, a recharging station, and a telescoping video and audio feed unit. The aerodrome can be remotely operated, and can be mounted on a roof of a structure or vehicle, allowing a completely automated service of the UAV without the need of a person being physically present in the vicinity of the UAV.

### BACKGROUND

Unmanned Aerial Vehicles (UAVs), more commonly known as drones, have only recently reached critical mass in the civilian market. As of February 2016, about 325,000 civilian drones were registered with the Federal Aviation Administration (FAA). While most commercial and military drones have dedicated ground crew and service locations to maintain and service the drones on a regular basis, the logistics of a personal, civilian drone is much more involved.

Specifically, the logistics to launch and land a UAV have not been as well developed as the drone technology itself. For the average civilian user, launching a drone involves at least a person being present at the launch site to prepare pre-flight routines before launch and to retrieve the drone once it has finished its flight operations. While civilian UAVs are known to be very portable and easy to transport, it is desirable for more routine day-to-day UAV operations to have a dedicated area or enclosure that allows the UAV to be stored, serviced, and maintained within the same area or enclosure to more rapidly deploy the UAV and increase the user's actual flight time—hence the aerodrome.

The above factors contribute to the general inconvenience of operating UAVs especially if the user only has a few minutes to make a quick flight. The non-flying activities greatly frustrate the user, making the few minutes of actual flight time less enjoyable. It is the purpose of this invention to help substantially minimize the user interaction necessary for pre- and post-flight operation to maximize user time actually flying the drone. This invention provides the UAV with a “drone valet” that automates the pre and post flight operations at the aerodrome.

Furthermore, the invention also includes a vivid telepresence sensation for the user with the camera system mounted to the aerodrome working in concert with the onboard drone camera. The AV feed from both the on-board UAV camera (providing the first-person view) and the tower camera (providing a third-person view) can be projected onto a screen, such as a screen of a phone, tablet, TV or any other screen including virtual reality headset devices to give the user an almost true flight sensation of the UAV.

### SUMMARY OF THE INVENTION

The Invention is a multi-purpose aerodrome for UAVs that automates remote storage, charging, and pre- and post-flight operations for UAVs. Using a collection of servos and microcomputers, the invention transforms from a storage enclosure to an intelligent flight deck that reacts to UAV telemetry.

In the preferred embodiment, the aerodrome comprises an enclosure for a UAV that can be mounted on a structure such as a roof of a building or a vehicle. The aerodrome is further comprised of a sensor mast (or shaft), a flight deck, and a service interface that can connect to the UAV for various functions.

The aerodrome enclosure provides a space to store and protect (from the elements/weather) at least one UAV when not in use. Additionally, the enclosure also stores and protects (from the elements/weather) the sensor mast in the binnacle area with iris door when it is not in use. The enclosure can transform into a flight deck and service center for the UAV when it is activated for use. Specifically, the flight deck arises from inside of the enclosure, preceded with the roll top door rolling up and the side walls opening to accommodate the unfolding of the flight deck. The enclosure can be mounted on an elevated portion of a structure, such as a pole, a roof, or a side of the roof to maximize free airspace without obstacles such as trees or branches during the launch and landing sequence.

Alternatively, the enclosure can also be mounted on top of a vehicle such as a utility vehicle, a minivan, bus, ambulance, firefighter engine, military or police vehicle and the like. In the preferred embodiment, the enclosure is connected to a power source that allows it to operate remotely and provide services to the UAV to eliminate hands on pre- and post-flight operations. It should be noted that the power source can be either an external source, or an internally built in power source.

The sensor mast is a motorized column of telescoping tubes that projects video, audio and weather sensors outside the device to gather pre-flight weather conditions and relay them to the user. The sensor mast is stowed inside the enclosure when it is not in use. The sensor mast is further equipped with at least one camera, one microphone, and a multitude of weather sensing devices including but not limited to barometer, thermometer, and hygrometer, which are essential to relaying the immediate area's weather condition to the user during preflight and flight operations.

The flight deck serves as the surface on where the UAV is stowed when not in use, and is equipped with a plurality of motors that can elevate the UAV when the roll top door and enclosure walls are opened for takeoff and landing. The flight deck also uses the plurality of motors to adjust the position of the UAV so that it can be moved and oriented toward the service interface in instances when the UAV lands on the flight deck, but is not properly oriented or located in a way that allows the service interface to access the UAV's service interface.

The service interface has the analogous function of a refueling ground crew on a traditional aircraft. In this case, the aerodrome provides for an automated experience where the service interface allows the UAV to recharge its battery directly from the aerodrome and download data from the UAV's data storage unit.

In a possible use scenario, a UAV is stowed inside the enclosure and ready to fly at a moment's notice. First, the user deploys the sensor mast to scout the pre-flight conditions outside of the enclosure, including weather condition, wind speed, and whether there are objects that may hinder flight operations around the enclosure.

Once the user determines the space is clear for flight operations, the user can initiate launch operations, at which time the roll top door on the enclosure opens, and the flight deck elevates from inside the enclosure bringing the UAV vehicle to the surface for take-off. During this process, the sensor mast's audio and video sensors are directed to the flight deck, so the user can see the UAV as if he or she were standing several feet away from the UAV.

The user can now begin take-off with two visual inputs; one from the camera mounted directly to the UAV, which will give a first person view (FPV) from the UAV's perspective, and a third-person view (TPV) from the video input source located in the sensor mast. Once the UAV takes off and flies out of the range, the video output on the monitor changes to the UAV's first person camera view.

Once the user is ready to land the UAV, the user can fly the UAV toward the aerodrome. Once the UAV is within the landing zone on the flight deck, the main monitor will automatically switch the display from the UAV's first person camera back to the third-person view, such that the user has two perspectives when maneuvering the UAV for landing on the flight deck as viewed from the multiple displays. A fence may also be used to reduce the risk of the UAV from falling off the flight deck during the landing sequence.

Once the UAV has been safely landed on the deck, computer software will determine the position and orientation of the UAV relative to the service interface. The flight deck is equipped with a plurality of motors that can apply impulse forces that can move the UAV toward the service interface translationally and/or rotationally. In this two-step process, the UAV is first situated within reach of the service interface translationally, then the software directs the flight deck to apply rotational impulse forces such that the UAV's service port is oriented with the service interface.

Once the UAV has been properly situated, the service interface connects with the UAV to recharge its flight battery and/or download the data from the UAV gathered during flight. Meanwhile, and before the UAV is powered down, mission data can also be downloaded wirelessly to another hard drive for storage and review. The UAV can now be stowed back into the enclosure, to fly out later with a fully charged battery and empty recording media storage.

### BRIEF DESCRIPTION OF DRAWINGS

These and other features, aspects, and advantages of the present invention will become better understood with regard to the following descriptions, appended claims and accompanying drawings where:

FIGS. 01A, 01B, and 01C show the perspective views of the UAV aerodrome in its various operation state, ranging from closed position, to opening, and fully opened and ready for flight operation.

FIGS. 02A, 02B, and 02C show the alternate perspective views of the UAV aerodrome in its various operation state, ranging from closed position, to opening, and fully opened and ready for flight operation.

FIG. 03 shows the exploded view of the UAV aerodrome showing all the elements and parts of the preferred embodiment.

FIG. 04A shows the top view of the flight deck of the preferred embodiment of the UAV aerodrome.

FIG. 04B shows the bottom view of the flight deck of the preferred embodiment of the UAV aerodrome.

FIG. 05A shows the top isometric view of the flight deck of the preferred embodiment of the UAV aerodrome.

FIG. 05B shows the bottom isometric view of the flight deck of the preferred embodiment of the UAV aerodrome.

FIGS. 06A and 06B show the perspective views of the impulse towers that also function as an elevator for the flight deck.

FIG. 07 shows an exploded view of one of the impulse tower.

FIG. 08 shows a cutaway view of one of the impulse tower.

FIGS. 09A, 09B, 09C, and 09D show the step by step process of the sensor mast deploying from inside of the enclosure into ready position.

FIG. 10A and 10B shows the exploded view of the retractable sensor mast, with FIG. 10A showing the external sleeve and parts, and FIG. 10B showing the exploded view of the internals of the retractable sensor mast.

FIG. 11 shows the cutaway view of the retractable sensor mast.

FIG. 12 shows the action sequence where the UAV is ready for take off, while simultaneously depicting the different vantage points of the main video output and tablet video output as seen by the user.

FIG. 13 shows the action sequence where the UAV is in flight and out of range of the aerodrome, at which point main video output clones the tablet video output as seen by the user.

FIGS. 14A, 14B, and 14C show the action sequence of the flight deck applying impulse force to the UAV to move the UAV from its landing spot toward the center of the flight deck.

FIGS. 15A, 15B, 15C, and 15D show the action sequence of the flight deck applying impulse force to the UAV to rotate the UAV to the proper orientation such that the UAV's service interface is aligned with the aerodrome's service interface.

FIG. 16 is a hardware architecture diagram showing internal electrical connections via the wiring harness, and external connections via the external cable and junction box.

FIG. 17 is a software architecture diagram summarizing the three software environments operating within the device, their functional roles, and the communication protocols they use to interact.

### REFERENCE NUMBER INDEX

100 Enclosure & Structural

101 Floor

102 Outer wing (L 103, R 104)

105 Wing vent

106 Wing hinge

110 Roll top

111 Roll top roller

112 Roll top guide

113 Roll top tractor

114 Roll top motor

115 Weather seal/UAV bumper

120 Binnacle

121 Binnacle sides (L 122, R 123)

124 Binnacle top

130 Frame

140 Iris door

141 Iris door motor

150 Installation plate

160 UAV

161 UAV Camera

162 UAV Propeller

163 UAV Service Interface

200 Flight Deck

201 Center section

202 Deck wing (L 203, R 204)

205 Carbon Fiber Ribs

206 Deck hinge

207 Deck ring

208 Perimeter fence

210 Runway lights

211 LED beacon

212 LED strip

220 UAV touchscreen

221 Capacitive sensor

225 Microcontroller PCB

230 Motor pop-up

231 Service Interface pop-up

300 Impulse Tower

301 Housing

302 Pin header

310 External motor

311 Timing belt with idler pulley

312 Input shaft

313 Transmission

314 Radial bearings

320 Elevator ring

321 Ballscrew shaft

322 Linear bearing & rod

330 Impulse cap

331 Impulse drive shaft

332 Whitworth linkage

333 Ring gear

334 Aiming motor

400 Sensor Mast

410 Deployment mechanism

415 Powered hinge

416 Pivot gear

417 Pivot motor

418 Pivot motor housing

420 Telescopic tubes

421 Drawstring

422 Drawstring reel

423 Drawstring motor

424 Extensible cabling

425 Return spring

430 LOS camera A line-of-sight (LOS) camera

431 Camera dome

432 Camera gimbal

433 Gimbal servos

440 Directional microphone array

450 Wind vane

451 Anemometer

500 Electrical

501 SBC (Single Board Computer)

502 SBC hard drive

505 Servo control PCB

506 Support electronics PCB

510 5V power supply

511 12V charging power supply

520 Wiring harness

530 Charging dock

531 Docking arm

532 Battery LED sensor

533 Battery button actuator

534 Ground Docking Leads

560 UAV retrofit

561 UAV terminal PCB

562 UAV Docking leads

570 External cabling

571 External cabling inlet

580 Junction box

600 Software

610 Server

630 Microcontroller

650 Mobile UI

701 Tablet video output

702 Main video output

### DETAILED DESCRIPTION OF THE PREFERRED EMBODIMENT

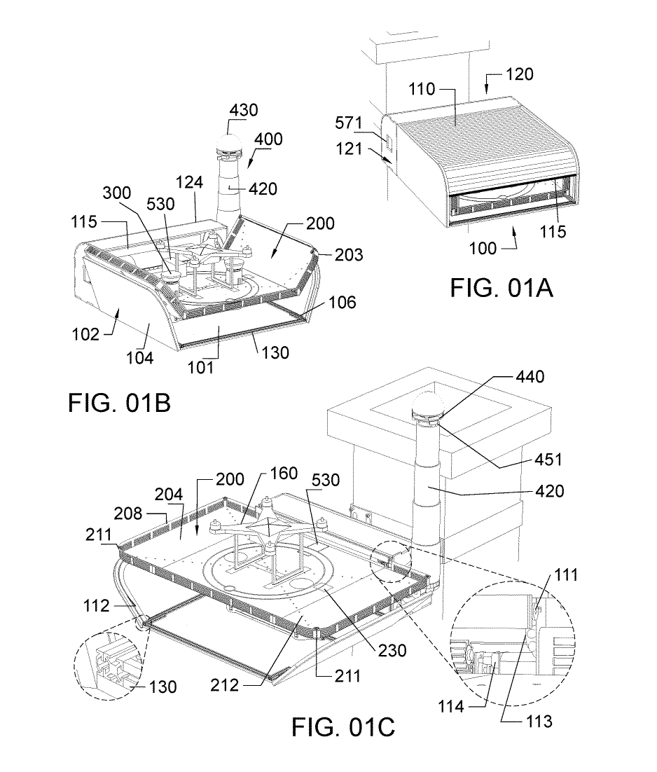

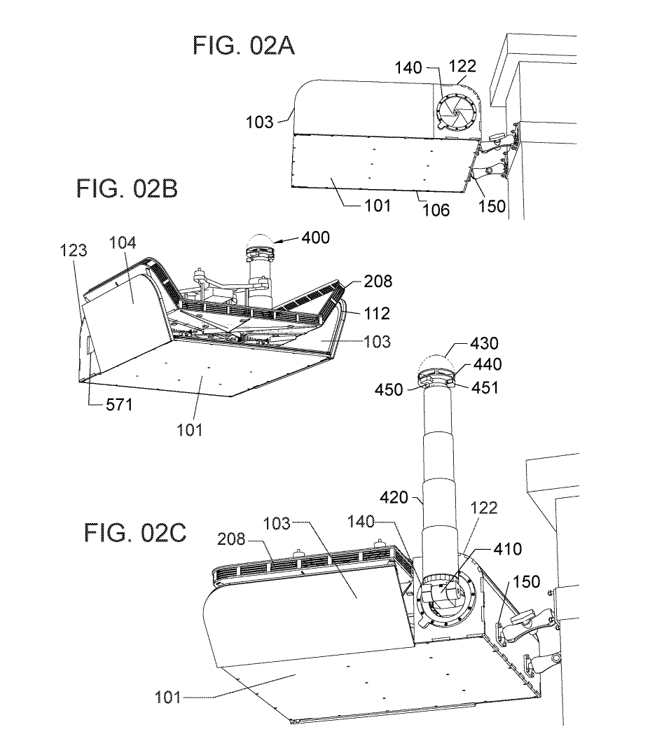

Looking at FIGS. 01A, 01B and 01C, the enclosure 100 comprises of a Enclosure and Structural Floor 101 spanning the length and width of the device. The floor and frame combine as a framework providing both structural strength and attachment points for assembly. The outer wings are left 103 and right 104. The outer wings rotate 45 degrees during the opening sequence, releasing the rising deck wings to reach 90 degrees flat. Along the lip of the inside surface runs a roll top guide formed as an inner channel, said guide controlling the path of rollers connected to the edge of the roll top. Said channel also serves as a rain gutter guiding water to vents at the front of the enclosure.

The wing vent mechanism 105 allows venting through screened slats in the wings, managed automatically to balance interior temp/humidity readings against exterior ones. Actuation is by sprung solenoid which defaults to closed. This system is a precursor to full environmental controls. Each wing has two wing hinges 106 that attach it to the frame and provide a pivot point. The roll top 110 is an articulating roll top formed from interlocking slats. Holes machined under its long edges engage a driven tractor wheel to extend and retract the top. When extended, the roll top holds the outer wings closed with its rollers. It forms a roof to protect the UAV from the elements, shunting rain into the side gutters. When retracted, the roll top is coiled into the outermost volume of the binnacle, saving the center for electronics and the sensor mast.

The roll top roller 111 has guide wheels attached to the edge of the roll top. These roll within the roll top guides of the wings and binnacle. Since the rollers are fully contained in the wing guides, the enclosure is effectively locked when the roll top is extended. The roll top 112 guide is a T-shaped groove running along the inner edge of the outer wings, mating with identical spiral guides in the binnacle to form a continuous path for the roll top between open and closed. The roll top tractor 113 drives an axle to rotate studded traction wheels engaging holes along the edge. The roll top motor 114 is a reversible stepper motor with appropriate gearing to drive the roll top tractor.

The weather seal/UAV bumper 115 on the leading edge of the roll top is constructed of softer material e.g. rubber to serve double duty as a weather seal when the roll top is closed, and a UAV bumper when its retracted. The binnacle 120 is the rearmost volume of the enclosure is home to the roll top in its coiled state, and the electronics tunnel for the tower sensor mast. One side of the aerodrome embeds an iris door to release the sensor mast. The right side embeds a hinged door covering the cable inlet. The binnacle sides 121 (L 122, R 123) comprise two verticals of a box structure, joined with the floor using dovetail joinery and with the frame using nuts and bolts. The binnacle top 124 the top surface of the binnacle.

The frame 130 is structural frame comprised of extruded aluminum beams welded at their seams. The iris door 140 was chosen given the wall-to-wall span of a retracted roll top, space constraints within the binnacle led to an external iris door design. This external door is operated by an internal motor connected to its gear housing through a hole in the binnacle. The Iris door motor 141 is a bidirectional motor to open and close the iris door.

The mounting installation plate 150 is a reinforced frame member pre-drilled for aftermarket ball-and-socket mounting systems e.g. RAM Mounts. Mounting can be achieved with at least one ball, but additional balls may be added to further secure the mount in adverse weather conditions.

The flight deck 200 is comprised of a center section 201 and deck wings 202 (L 203, R 204) with carbon fiber ribs 205 with reinforcement slats giving strength to the deck's center section and wings. Material used in the embodiment is carbon fiber plate, but other suitable materials may be chosen. The wings 203 and 204 are connected to the deck via a deck hinge 206. The deck ring 207 is the middle of 3 vertically interlocking rings, the deck ring floats between the lower elevator ring and the impulse cap above. To transition between rings, the deck is raised above nominal which deploys latching clips in the impulse cap, switching the entire flight deck from the up/down or “Z-axis” motion of the elevator, to “X-axis and Y-axis” impulses in the plane of the flight deck.

A perimeter fence 208 helps keep the UAV on the flight deck. When landing, side-skips and bounces are common occurrences. If unchecked, they may cause a UAV to “walk off” the ledge. A perimeter fence (just higher than a typical hop) confines the landing gear to the flight deck.

The flight deck 200 also contains runway lights 210, LED beacon 211, LED strip 212. The UAV touch screen 220 is an array of capacitive sensors for locating a UAV on the flight deck. Greater acuity is needed near the center, where the UAV is positioned and oriented for docking; therefore, an asymmetric arrangement is used to concentrate more sensors there. The capacitive sensor 221 is a contactless sensor that uses capacitance to detect the proximity of objects with a different dielectric constant than air. In the embodiment, the contact point of a UAV leg resting on the flight deck is detected.

The microcontroller PCB 225 is used to reduce control lines from the wiring harness, a microcontroller on the flight deck manages all local components, said microcontroller managed in turn by the master Single Board Computer (SBC) via an IC serial bus since the flight deck contains a large number of addressable components like runway lights and touch screen sensors. The motor for the impulse towers is located beneath the flight deck, so a pop-up cage is used with the motor forming the motor pop-up.

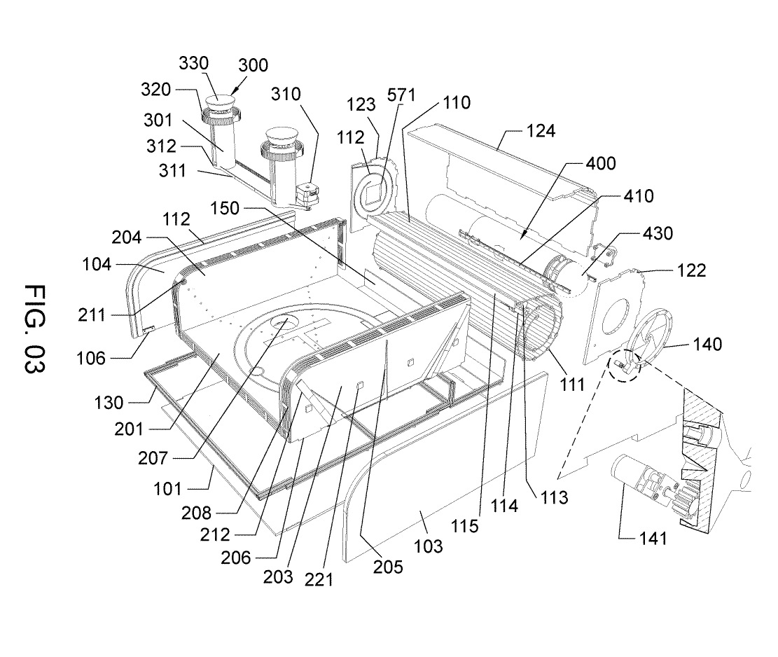

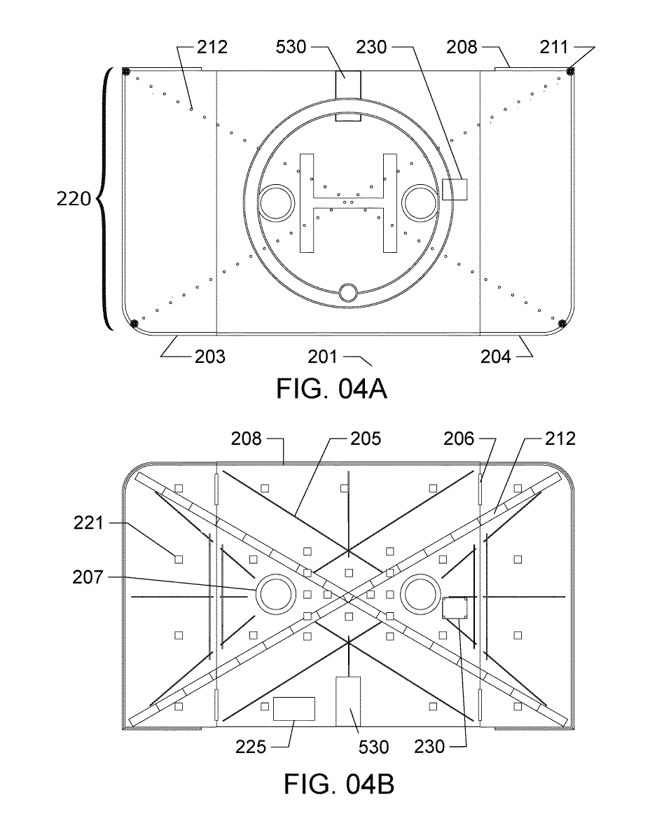

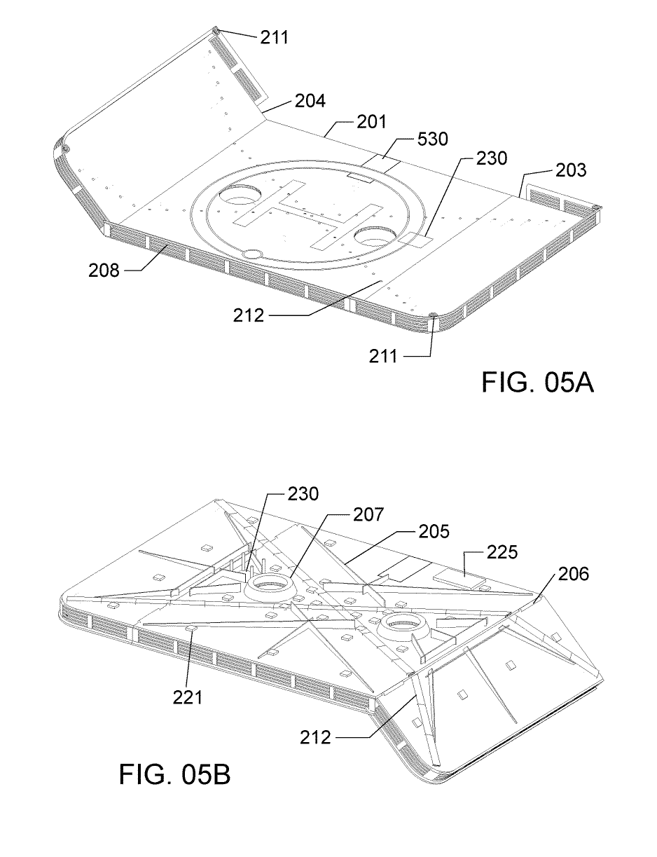

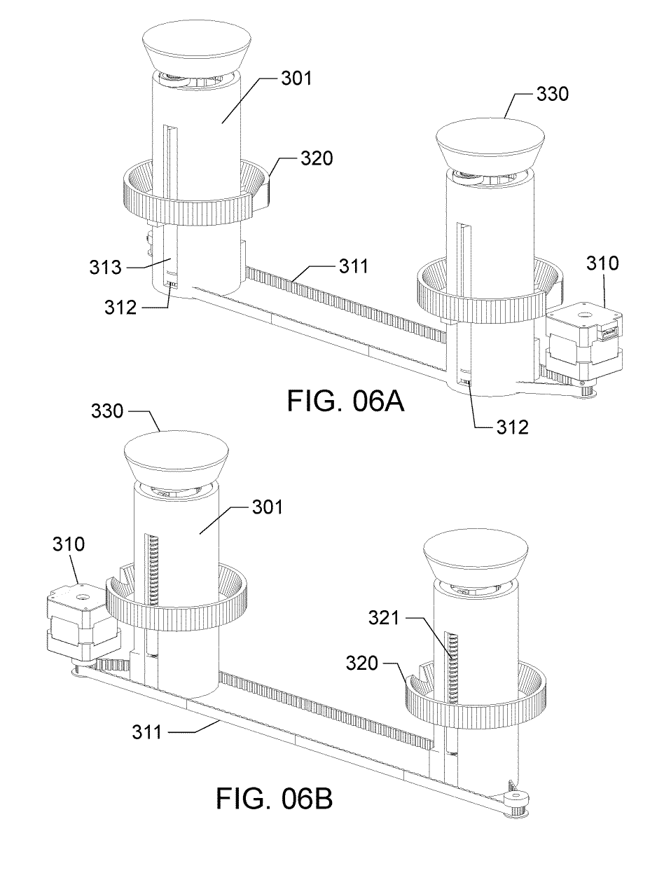

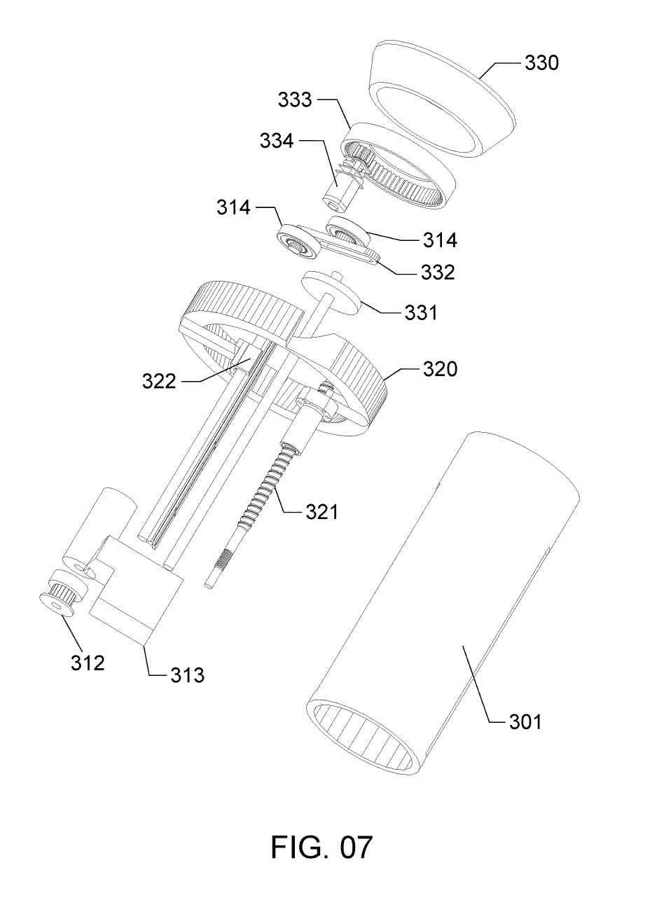

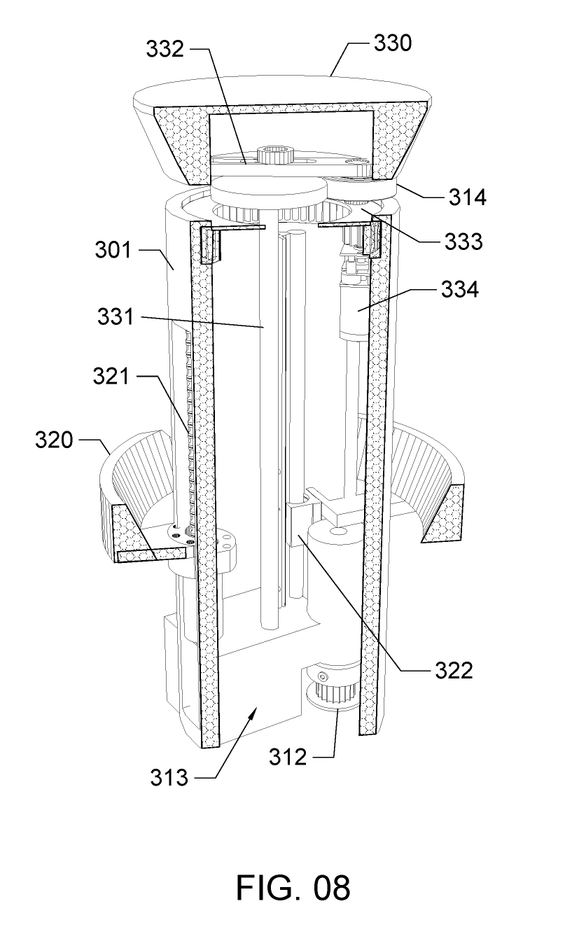

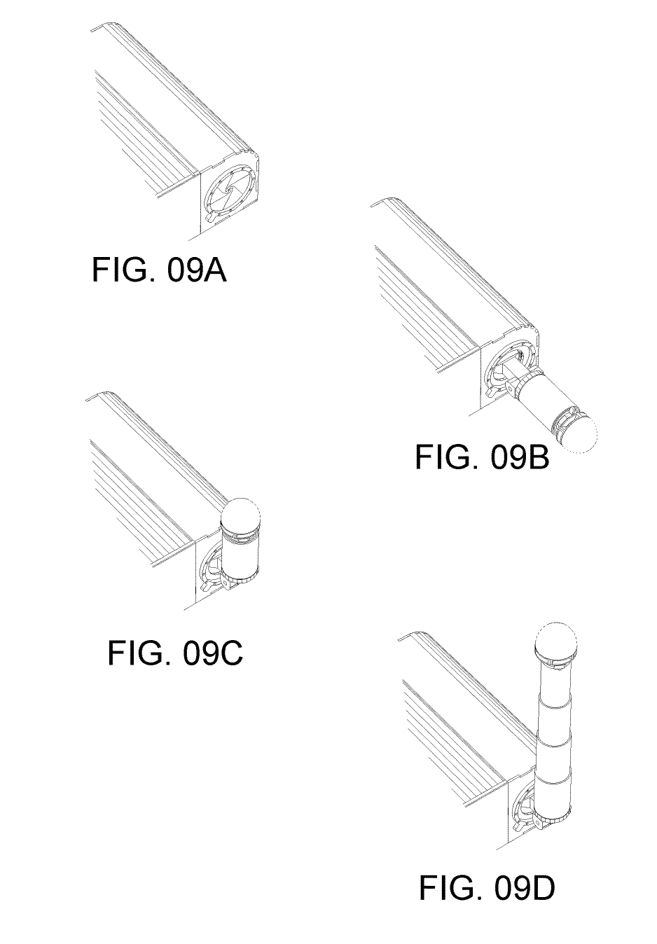

The impulse tower 300 consists of a housing 301, pin header 302, external motor 310, timing belt with idler pulley 311, input shaft 312, transmission 313, radial bearings 314, elevator ring 320, ball screw shaft 321, linear bearing and rod 322, impulse 330, impulse drive shaft 331, Whitworth linkage 332, ring gear 333, and aiming motor 334 depicted in FIGS. 03, 06, 07, and 08. The housing 301 is formed by a two-piece container holding the elevator and impulse mechanisms. Its construction is like an engine block, lying in two halves to expose half-circle bearing sleeves. Mating the halves mates the sleeves, encircling the bearing jackets.

The pin header 302 consists of a ribbon cable header, connecting the transmission and aiming motor to the wiring harness. The external motor is a stepper motor powering the tower's input shaft. The timing belt with idler pulley 311 conveys synchronized power from the external stepper motor to both impulse towers. An idler pulley is slide-mounted to the frame to adjust belt tension. The input shaft 312 conveys power from the timing belt to the transmission's driven gear. The transmission 313 routes power from the input shaft to one of two drive shafts, through a gear reduction per shaft. A servo-driven pinion gear switches power between the shafts. The radial bearings 314 provide smooth operation of the drivetrain and runs primarily through radial bearings for precision, also to prevent backlash from powerful impulse forces.

The elevator ring 320 the lowest of 3 vertically interlocking rings, the elevator ring is attached to, and elevated by a ballscrew. Since the deck ring sits on this elevator ring, raising the elevator raises the deck as well. At the top of its travel, the deck ring presses against the spring-loaded impulse cap which captures it with a toggle latch. To lower the deck, the deck repeats the upward push, toggling the spring latch to release the deck onto the elevator once again. The ball screw shaft 321 elevates the flight deck by means of so-called elevator rings attached to the ballscrew nut. The linear bearing and rod 322 work in conjunction with and cooperates with the ballscrew shaft to stabilize the vertical path of the elevator ring.

The impulsive cap 330 covers the impulse drive shaft 331 which rotates a flywheel at the top of the shaft to which a locator pin is attached. The rotating pin reciprocates the follower of a Whitworth quick-return linkage 332 in conjunction with the ring gear 333 and aiming motor 334, each cycle delivering one impulse to the flight deck. A Whitworth is a linkage used to convert rotational into reciprocal motion, with a distinctive quick-return phase at the end its cycle. Flight deck impulses are imparted from the slower “grip” phase of this grip/slip cycle, with the quick-return overcoming static friction between the UAV's feet and the surface of the flight deck to slip the deck backwards under the UAV. The flight deck always returns to its original rest position after each of the impulse cycle ends.

The sensor mast 400 is a motorized column of telescopic tubes that projects video, audio, and weather sensors outside the device. Other sensors may be optionally included such as thermal sensors for night vision. The mast cantilevers from its iris door, rotates 90 degrees, then extends upward to position telepresence sensors (audio and video) at a height approximating the perspective of a human operator.

A deployment mechanism 410 is used to deploy the sensor mast which extends on a sled, which in turn is mounted to a slide rail attached to a timing belt. At the end of the sled's travel, a powered hinge 415 activates to rotate the digital periscope 90 degrees to vertical utilizing pivot gear 416, pivot motor 417 and pivot motor housing 418. Once vertical, the telescopic tubes 420 extend to raise the sensor mast via a block and tackle system formed into the cylinder walls. Static pulleys guide a drawstring through a looping path that runs through the bottom of each cylinder, resulting in a lifting force when the drawstring is drawn thus extending the sensor mass digital periscope.

Construction of the tubes are machined to nest smoothly. Rectangular grooves are then cut in the inner walls to receive snap-in cartridges containing the block & tackle system. Separating the pulley design to a snap-in cartridge reaps several benefits over the alternative of forming complex designs on an inner wall: a) iterating pulley designs means iterating a cartridge, not the whole pipe, b) forming the cartridge outside the cylinder allows cheaper Computer Assisted Manufacturing (“CAM”) processes such as 3D printing, injection molding, or 2.5D CNC.

The drawstring 421 is a large gauge monofilament (e.g. 0.05″ fly-fishing line) used as the sensor mast drawstring. The drawstring reel 422 a take-up reel positioned just below the telescopic tubes. The reel is rotated by the drawstring motor to pull the drawstring and extend the mast. The drawstring motor 423 a reversible gear motor mounted at the center axis of the sensor mast to rotate the drawstring reel. The extensible data cabling 424—like the drawstring—is also routed through the cylinder walls in such a way as to extend along with the mast. In the embodiment, flat ribbon cables are folded in a repeating 90-degree pattern which loops around the bottom of each pipe, clipped into machined depressions matching the cable's thickness. The return spring 425 is embedded in the cylinder walls exert a retraction force on the mast, opposing the extension force of the drawstring. These springs complement gravity to retract the mast fully.

The line-of-sight (LOS) camera 430 serves as the remote “eyes” of an operator providing a third-person perspective. The camera extends above and behind the device to approximate a virtual ground launch. The camera's video feed is wired to the output device for low-latency feedback during UAV remote control. The camera dome 431 is a clear protective dome for the camera optics and gimbal. The camera gimbal 432 is a motorized 3D gimbal allowing software aiming of the camera. In particular, the camera auto-aims at the UAV whenever it's broadcasting GPS telemetry.

The gimbal servos 433 are two independent servos that control the horizontal and vertical movements of the gimbal, respectively. A directional microphone that can be arranged as a radial array of microphones 440 collects 360 degrees of audio to form a digital sound stage. This sound stage is oriented in software to align with the active view (LOS or FPV). The wind vane 450 is a shape mounted on a bearing and formed to “point” in the wind. A circle with a magnet is mounted coaxially to co-rotate through a fixed circle of Hall effect sensors to correlate wind direction. The anemometer 451 is a trio of air-catching shapes e.g. cups or cones, mounted symmetrically on a radial bearing. An infra-red sensor counts the passage of cone arms to calculate wind speed.

The invention is designed as a semi-permanent, weatherproof exterior fixture where a user may store a UAV on a regular basis. Interior and exterior temperature and humidity sensors are employed to keep the UAV and its charging system within operating range. When outside conditions are more favorable, vents may be opened for air exchange to regulate temperature and moisture inside the enclosure.

The UAV aerodrome can also be mounted on a vehicle for a mobile deployment. The enclosure is designed such that it can be mounted on top of a car, minivan, or emergency vehicle. It can also be mounted on aerial or water vehicles, such as a helicopter or a boat. The ability to operate UAVs from mobile vehicle can have extensive benefits for various work such as news reporting, emergency services, tourism, agriculture, and other fields.

In the preferred embodiment, the aerodrome provides battery charging and data transmission and retrieval services once the UAV lands safely on the flight deck, and the flight deck has been lowered so that the UAV can be serviced in a relatively safe environment. A propeller stop check may be implemented by reading the UAV's telemetry to ensure there are no moving parts when the UAV and the flight deck gets lowered into the enclosure.

A battery charging interface is present on the service interface unit, and connects to the battery charging port of the UAV. Alternatively, the UAV may also be recharged using an inductive charging or wireless charging protocol, which eliminates the need for a physical connection entirely.

On-board battery charging is enabled by means of a power terminal PCB retrofitted to the UAV's factory specification. The PCB allows the battery mains to be switched away from the UAV and onto charging current, employing a transistor for this purpose. To be clear, the unintentional activation of this transistor in-flight would result in catastrophic power loss and a certain crash, therefore a number of safeguards are employed by the power terminal PCB. First, surge protection delivers clean power to the microcontroller, which waits through 2 secs of in-range voltage before proceeding. It must then connect to the serial bus controller such as I2C bus and transact with the single-board computer (SBC) before finally switching to charging current. The transistor holds the charging line up explicitly while charging; in any other state or while in flight, the transistor's default state drops the line to connect the battery to the UAV.

In the preferred embodiment, the aerodrome also has a hard drive unit that allows data gathered from the UAV's previous flight operation to be transferred to the hard drive unit, thus clearing up the space for the UAV's next flight operation. The data in the hard drive, in turn, can be downloaded by the user at his or her convenience either manually, automatically, or on schedule. The data transfer may be achieved either through physical connection, or through a wireless data transfer. Additionally, the data may be stored to another local physical hard drive, or shared through a cloud data sharing system.

After landing, the UAV is located more or less randomly across the surface of the flight deck 200. In this state, the UAV is out of range of the charging dock 530 and also obstructs the various moving walls of the flight deck (flight deck wings 202, 203, 204), preventing closure. To correct this, impulse towers are employed to center and rotate the UAV using a series of motive impulses applied to the entire flight deck.

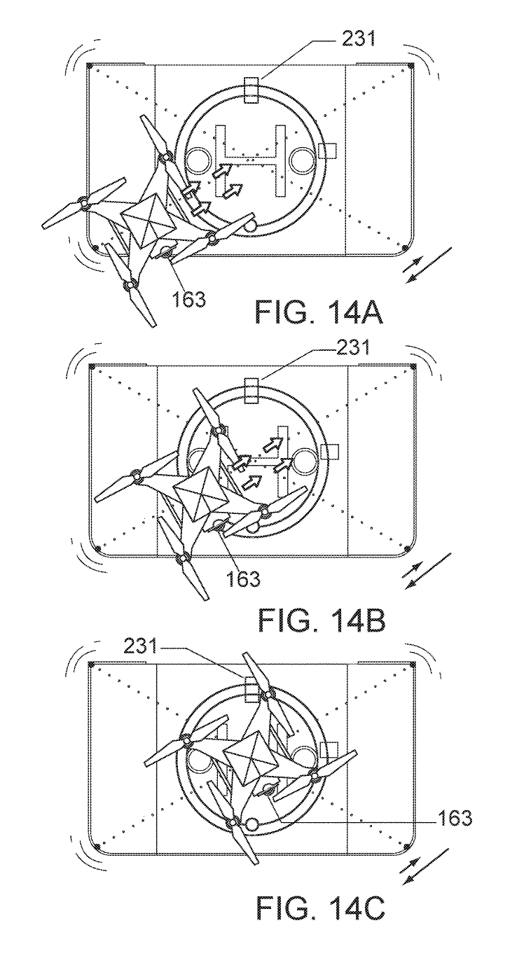

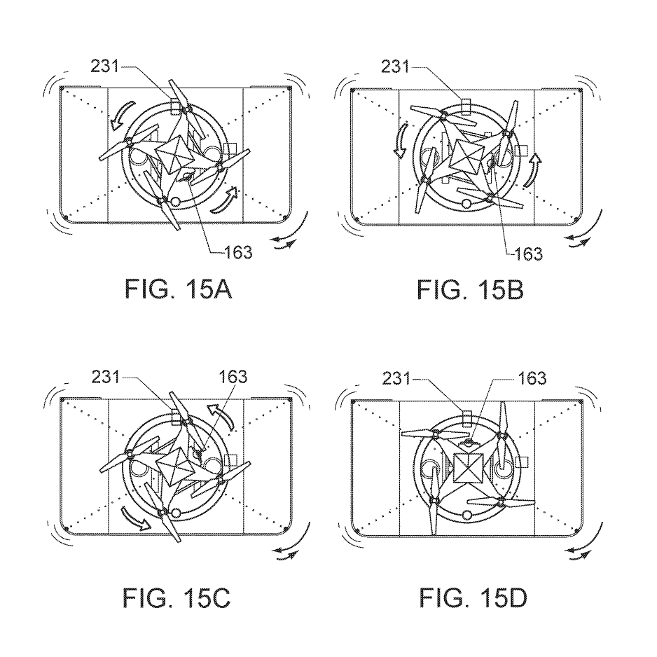

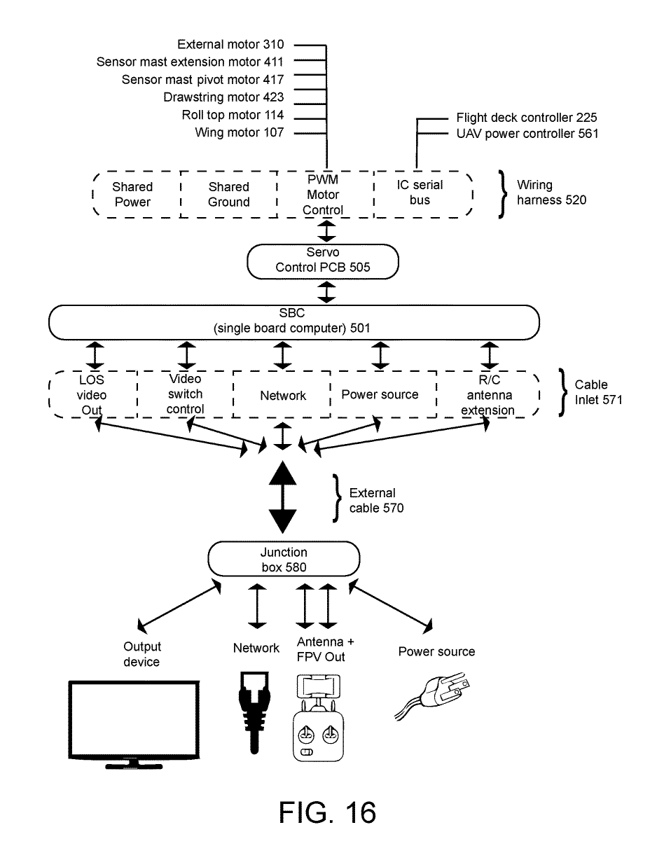

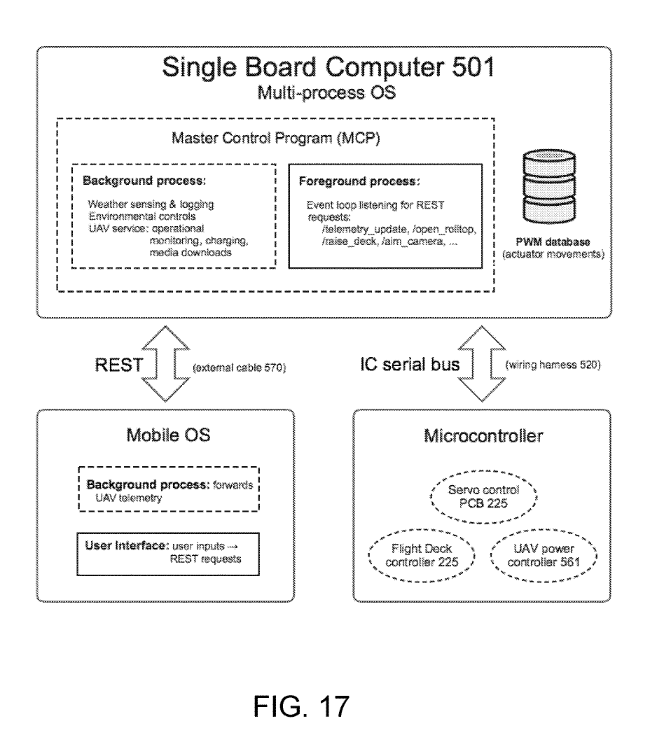

This docking sequence is triggered by the UAV's propellers powering down, definitively marking the end of a flight. Capacitive sensors detect the UAVs' position on the flight deck from which a vector is charted towards the center. Motorized aiming rings in both impulse caps align themselves in-phase and in-line with the desired vector, at which point a Whitworth mechanism embedded within the impulse caps is driven to generate impulses with a quick-return motion (depicted by arrow length in FIGS. 14 and 15), the hallmark of a Whitworth-based linkage. Within each cycle, the UAV is first pushed with a slow acceleration in the direction of the vector, accumulating inertia but still fixed on the deck via static friction of the UAV's feet. The quick-return phase then overcomes that static friction to dynamically slip the flight deck backward to its original position. The end result of this “grip-slip” locomotion is a centered UAV (FIGS. 14 and 15 show the sequence of applying translational and rotational impulse forces to align the UAV).

Once the UAV is centered and straddling the impulse caps with translational impulse forces as shown with straight arrows (FIGS. 14A, 14B, 14C and 14D), the caps realign themselves out-of-phase to impart rotational impulses (shown by arc-ed arrows) to the UAV, rotating it minimally clockwise or counterclockwise to orient its battery faceplate rearwards for docking at the service interface (FIGS. 15A, 15B, 15C, and 15D) as shown by the arc-ed arrows.

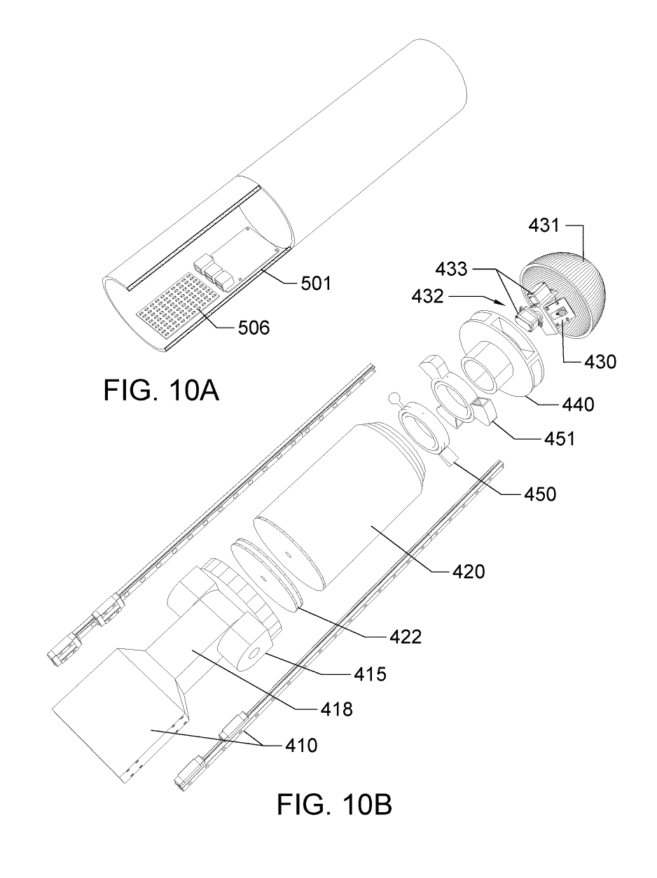

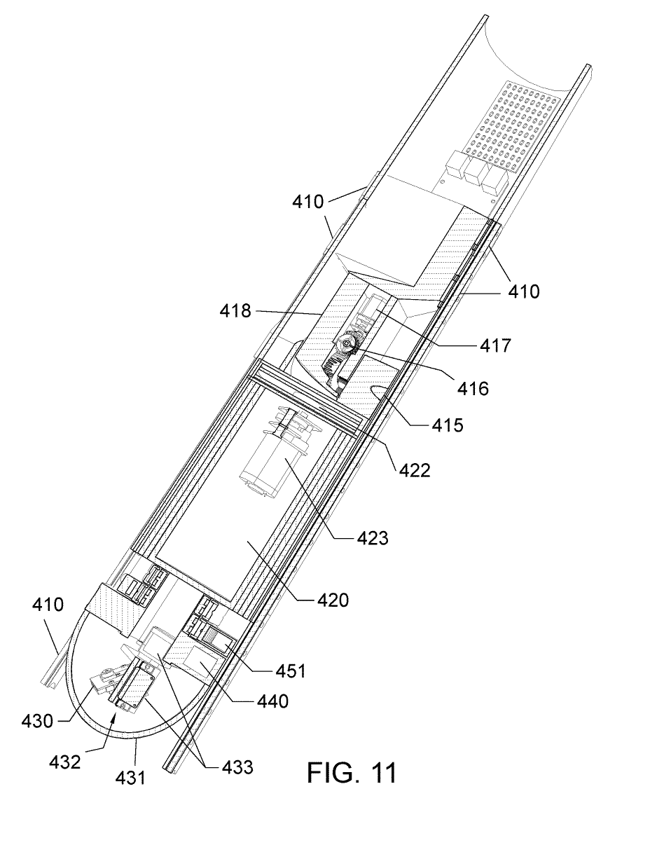

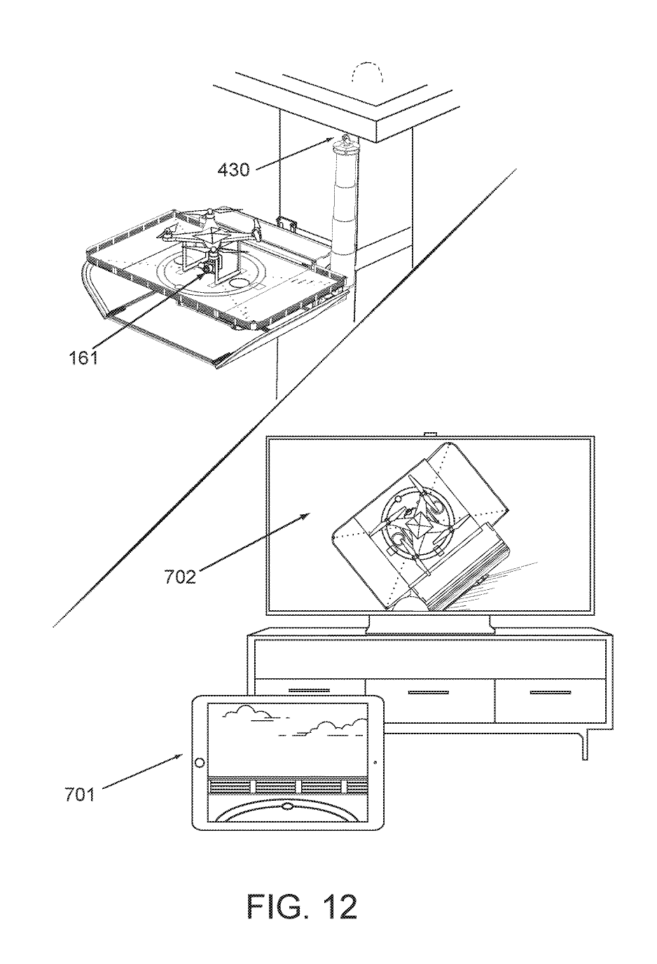

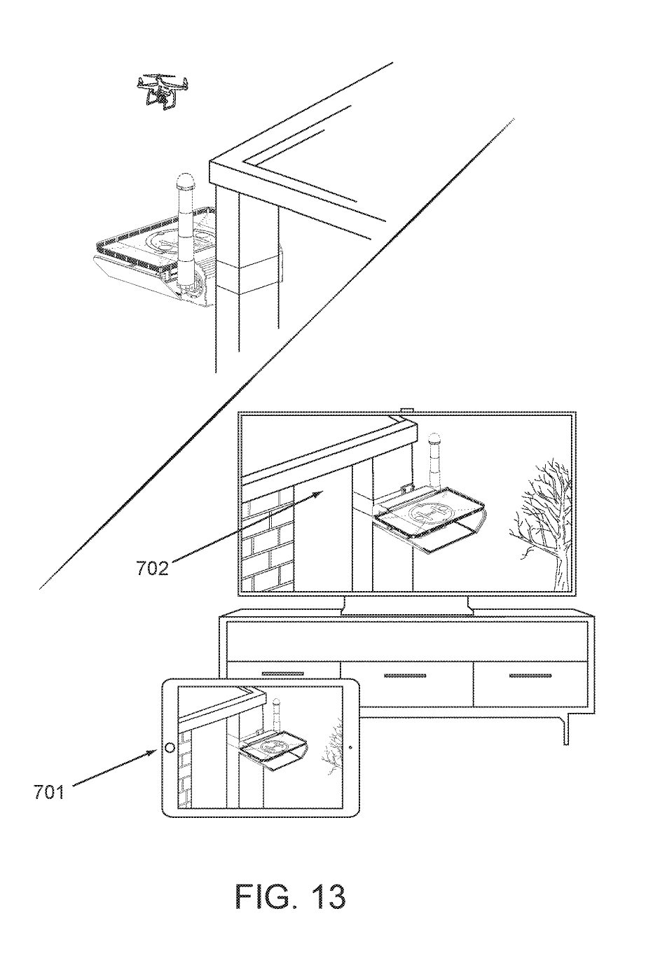

Each tower is equipped with opposing solenoids attached to a rotating ring letting us briefly “shove” the deck in any direction, damped by large silicone grommets on which the flight deck is suspended. When these impulses are in phase (FIG. 10), the UAV moves in a linear direction towards the center of the deck. At that point, out-of-phase impulses (still synchronized in time) are applied to rotate the drone to a parked position for mating with the charge tower. The rotational position of the drone is sensed by capacitive sensors in the center of the deck.

Random post-flight positions of the propeller blades are a significant challenge to minimize the overall size of the enclosure. An enlarged flight deck can accommodate the full sweep of all blades, but results in more flight deck area than desired. Thus, it is possible for a brush mechanism to be added to sweep the props into horizontal positions when lowering the deck allowing for positioning the UAV closer to the binnacle.

In the spirit of minimizing the aerodrome overall dimensions, whilst allowing enough room for the UAV and its blades, a study of the blade geometry with respect to the drone body was conducted. It was determined that by brushing the blades facing the back of the aerodrome to a parallel position (both blades parallel and both blades parallel to the battery faceplate or UAV service interface) optimized the flight deck area while minimizing the overall aerodrome dimensions. When the aerodrome is closed, the aerodrome fits the UAV with propellers installed, eliminating propeller swaps so that the UAV is flight-ready with only a moment's notice.

Two blades are swept currently (those closest to the binnacle), and the other two could be as well or not. However, the current size of the flight deck seems appropriate for safe, consistent landings, but another prop sweeper could be added. The sweeper could be attached to the server shelf under the roll top traction roller or any other suitable location.

When it is time to fly, the preferred embodiment of the aerodrome demonstrates its most dramatic feature: moving and rotating approximately 80% of its surface area to raise and unfold the flight deck from the enclosure, resulting in a flat launch platform with ample clearance from prop hazards. Simultaneously, the telescoping sensor mast emerges from an iris door on the side, extending out horizontally at first then rotating 90 degrees for its vertical extension.

In the preferred embodiment, the sensor mast combines a high definition Line-of-Sight (LOS) camera, directional audio microphones, and a simple weather station (wind speed and direction). Video and audio are combined to an audio-visual stream such as HDMI or other suitable interface to transfer compressed/uncompressed digital audio/video data delivering the first stage of telepresence: a perspective slightly above the flight deck which “feels” similar to a normal ground launch: the UAV is seen below the user, the battery faces the user, and the UAV is aligned with the RC controls. Auto-launch can be used here safely and consistently.

With the UAV launched and moving away, the Invention reacts to real-time telemetry to lower the deck and close the roll top once the UAV reaches a committed distance. The LOS mast extends vertically for maximum range and visibility, and at the top of the mast the gimbaled LOS camera maintains constant visual contact with the UAV, locked to its GPS telemetry. At a further distance, with the LOS camera losing sight of the UAV, the Invention's junction box auto-switches the user's telepresence to the second stage: a first-person view from the UAV's perspective.

Such perspective switches can be jarring on a large external monitor if video or audio perspectives are out of sync. For instance, if the LOS camera is looking out, but the First Person View (FPV) camera is pointed down during a camera switch, a “falling” sensation could result which is jarring to the user and should be avoided, and thus real-time viewing of all views desired.

To maintain visual continuity through the camera switch, the software always aligns the gimbal of the next view with that of the current view. This imparts a natural feeling to the switch in that both views are “looking at the same thing”. On the other hand, if the UAV is returning such that the cameras are facing each other, the next gimbal is aligned with a matching negative vertical offset to the current one, so that instead of “looking at the same thing” (as with a matching positive offset), the cameras instead are “looking at each other”.

Similarly, audio should be adjusted through transitions, avoiding something from the left suddenly sounding like it is from the right, therefore the orientation of the audio sound stage is digitally adjusted as well. Since UAVs typically do not record sound given any audio input would be drowned out by the noise coming from the propeller, colloquially known as “prop wash,” the preferred embodiment instead mixes LOS audio with FPV video, imparting a sense of virtual audio from the UAV's perspective. This directional audio track is managed in software to remain properly cued to what's on-screen on the monitor or TV at that moment.

At the end of each flight, the UAV is welcomed home by a series of actions triggered by its inbound telemetry: the roll top opens, the flight deck is raised, the sensor mast is lowered to clear the props. Outbound, these actions are reversed. At night, the deck opens sooner than in the daytime, to provide a distant homing reference with its lights. These scenarios and others demonstrate a system of reactive flight operations which integrate UAV telemetry with other sensor data to dynamically configure the device as needed.

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Although the present invention has been described in considerable detail with reference to certain preferred versions thereof, other versions are possible. Therefore, the spirit and scope of the appended claims should not be limited to the description of the preferred version contained herein.

I claim:

1. An aerodrome for a UAV, comprising:
a. An enclosure;
b. A retractable sensor mast;
c. A flight deck; and
d. A service interface.

2. An aerodrome for a UAV of claim 1, wherein said enclosure has a roll top door.

3. An aerodrome for a UAV of claim 2, wherein retraction of said roll top door exposes the flight deck.

4. An aerodrome for a UAV of claim 1, wherein said flight deck further comprises a plurality of motorized mechanisms to position the flight deck.

5. An aerodrome for a UAV of claim 1, wherein said flight deck further comprises a fence to keep the UAV on the flight deck.

6. An aerodrome for a UAV of claim 4, wherein said flight deck transitionally positions the UAV with impulses.

7. An aerodrome for a UAV of claim 1, wherein said flight deck further comprises sensors.

8. An aerodrome for a UAV of claim 4, wherein said flight deck further comprises motorized mechanisms to provide rotational impulses for orienting a UAV.

9. A retractable sensor mast assembly for aerodrome of UAV, comprising:
a. A housing;
b. A door;
c. A shaft;
d. A lifting mechanism;
e. An erecting mechanism;
f. An electrical conduit;
g. An Audio-Visual input device;
h. An I/O interface; and
i. Sensors.

10. A retractable sensor mast assembly for aerodrome of UAV of claim 9, wherein the door is an iris-style door that allows the shaft to exit the aerodrome.

11. A retractable sensor mast assembly for aerodrome of UAV of claim 9, wherein the shaft contains an electrical conduit for connecting sensors.

12. A retractable sensor mast assembly for aerodrome of UAV of claim 9, wherein the top of said shaft contains at least one camera.

13. A retractable sensor mast assembly for aerodrome of UAV of claim 9, wherein the top of said shaft contains at least one sensor.

14. A retractable sensor mast assembly for aerodrome of UAV of claim 9, wherein the top of said shaft contains at least one camera.

15. A retractable sensor mast assembly for aerodrome of UAV of claim 9, wherein the sensory data is linked to the I/O interface.

16. An aerodrome UAV service interface, comprising;
a. A docking area;
b. A locating system;
c. A docking station;
d. A power system; and
e. A recharging station.

17. An aerodrome UAV service interface of claim 16, wherein the docking area has at least one sensor for locating the UAV.

18. An aerodrome UAV service interface of claim 16, wherein the locating system locates the UAV to the service interface.

19. An aerodrome UAV service interface of claim 16, wherein the UAV connects to the aerodrome docking station for recharging.

20. An aerodrome UAV service interface of claim 16, wherein the UAV connects to the aerodrome docking station for transferring sensory data.

21. A method of positioning a UAV on a flight deck using impulsive forces having the steps of:
a. Determine the location and orientation of the UAV in relation to the surface interface on the flight deck;
b. Applying an impulsive force to move and orient the UAV toward the service interface;
c. Method of repeating steps a through b, until the UAV is close enough to the service interface to connect the service interface to the UAV.

22. A method of providing the user with first person real-time video from a UAV and third person real-time video feed from an aerodrome tower having the steps of:
a. utilizing AV equipment on the UAV;
b. utilizing the AV equipment on the tower;
c. displaying first person video and audio feed from the UAV camera to a first screen in real-time;
d. displaying third person video and audio feed from the tower camera to a second screen in real-time; and
e. Repeating steps, a through d, until the UAV lands and video feed is turned off by the user.
